(19) United States
(12) Patent Application Publication
(10) Pub. No.: US 2007/0239786 A1
(43) Pub. Date: Oct. 11, 2007

(54) SYSTEM FOR MAINTAINING REGULATORY COMPLIANCE OF COMMUNICATION POINT DATA

(75) Inventors: Michael B. Grear, Omaha, NE (US); Margaret Ann Henry-Saal, Omaha, NE (US); Patricia L. Melanson, Omaha, NE (US); Gretchen Donlin, Gretna, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/759,196

(22) Filed: Jun. 6, 2007

Related U.S. Application Data
(63) Continuation-in-part of application No. 10/972,172, filed on Oct. 22, 2004.
(60) Provisional application No. 60/812,006, filed on Jun. 7, 2006.
(60) Provisional application No. 60/567,891, filed on May 3, 2004.
(60) Provisional application No. 60/547,651, filed on Feb. 24, 2004.

(51) Int. Cl. G06F 17/30

(52) U.S. Cl. 707/104.1

(57) ABSTRACT

According to another embodiment of the invention, a method of formatting communication point data comprises storing a communication point data set; storing a plurality of communication-point-formatting data sets defining how to format the communication point data set, each of the plurality of communication-point-formatting data sets defining a respective format for the content as specified by a respective format setting entity; and associating one of the communication-point-formatting data sets with the communication point data set based upon the determined application.

### CROSS-REFERENCES TO RELATED APPLICATIONS

This application claims the benefit under 35 USC §119(e) of U.S. Patent Application No. 60/812,006, filed on Jun. 7, 2006, entitled “SYSTEM FOR MAINTAINING REGULATORY COMPLIANCE OF COMMUNICATION POINT DATA”; and this application is a continuation-in-part of U.S. patent application Ser. No. 10/972,172, filed Oct. 22, 2004, entitled “SYSTEM FOR MAINTAINING COMMUNICATION POINT DATA”, which claims the benefit under 35 USC §119(e) of U.S. Patent Application No. 60/547,651, filed on Feb. 24, 2004, entitled “SYSTEM AND METHOD FOR TRANSACTION PROCESSING”, and which claims the benefit under 35 USC §119(e) of U.S. Patent Application No. 60/567,891, filed on May 3, 2004, entitled “SYSTEM AND METHOD FOR TRANSACTION PROCESSING”; and all of the above applications are hereby incorporated by reference in their entirety for all purposes.

According to one embodiment of the invention, a system for maintaining communication point data can be implemented. For example, a system for configuring communication point data to match regulatory requirements can be implemented.

### BACKGROUND

Credit card transaction management and administration is an example of a processing system that has traditionally relied on storing a great deal of information with a single identifier used as a reference. For example, a credit card account typically includes information about the customer, the account, the billing address, the formal transaction information, and the credit card and physical credit card characteristics. All of this is handled from the perspective of a single account, so that the credit card company can track transactions for a particular customer. Thus, this results in a very static data processing system that is inflexible which makes it difficult to effect changes as the business it services evolves. Furthermore, the handling of this information is typically specific to a particular line of business within an industry such as a revolving credit product for the financial services industry. It is not readily aligned with a totally different service model, such as one's utility billing system, insurance claim payment processing system, phone billing system, or cable billing system.

Thus, a third party which handles the processing of transactions for a variety of different industries or services must create independent systems for handling each service's transactions. There currently appears to be no unique system which is capable of flexibly handling different types of services, such as credit card processing, healthcare claim payment, and utility bill processing, in the same processing system. Again, the static and inflexible nature of the current processing systems prevent this.

In addition, because the account information, party information, communication point information, and presentation instrument information for a credit card system, for example, is referenced by a single identifier, it is quite difficult, if not impossible, under present systems, to manage the individual areas of account information, party information, or presentation instrument as independent data. Once again, the inflexible nature of a single reference to the data prevents this from happening.

Furthermore, communication point data may need to be revised to accommodate different formatting requirements of different regulatory entities. For example, the US postal service requires a certain address format to be used on letters in order to qualify for a reduced mailing rate in the United States. Therefore, a company that mails many letters will want to format the mailings in accordance with the US Postal Service's requirements in order to obtain the discount. In other instances, other postal services will require a different mailing format. Similarly, for other types of communication point data, different formats may be required. In addition, the required format or standard for this information may change from time to time. Thus, existing systems that utilize static records would not be able to accommodate such modifications.

Thus, there is a need for a data processing system which can handle the processing of data for service industries in a more flexible manner. For example, there is a need for a data processing system and requisite data architecture that can easily adapt to changing business requirements and is not tightly coupled with a specific aspect of any one service or any one industry.

### SUMMARY

According to one embodiment of the invention, a method of addressing a letter is disclosed wherein the method comprises storing a communication point data set, the communication point data set comprising data for addressing an item of mail for mailing via a postal service; storing a plurality of postal formatting data sets defining how to format the communication point data set, each of the plurality of postal formatting data sets defining a respective addressing format specified by a respective postal service.

According to another embodiment of the invention, a method of formatting communication point data comprises storing a communication point data set; storing a plurality of communication-point-formatting data sets defining how to format the communication point data set, each of the plurality of communication-point-formatting data sets defining a respective format for the content as specified by a respective format setting entity; and associating one of the communication-point-formatting data sets with the communication point data set based upon the determined application.

According to still another embodiment of the invention, a method of formatting communication point data comprises storing a communication point data set; storing a plurality of communication-point-formatting data sets defining how to format the communication point data set, each of the plurality of communication-point-formatting data sets defining a respective format for the content as specified by a respective format setting entity; determining an application for the communication point data set; associating one of the communication-point-formatting data sets with the communication point data set based upon the determined application; applying the associated communication-point-formatting data set to the communication point data set so as to produce a formatted communication point data set, the formatted communication point data set being different from the communication point data set; outputting the formatted communication point data set to the application; updating the communication point data set with revised data; updating at least one of the communication-point-formatting data sets in response to a revised format from the respective format setting entity.

Further embodiments of the invention will be apparent from the following detailed description and accompanying figures.

### BRIEF DESCRIPTION OF THE DRAWINGS

FIG. 1A is a block diagram illustrating the architecture of a data processing system for managing service industry data according to one embodiment of the invention.

FIG. 1B illustrates a data processing system for implementing the architecture shown in FIG. 1A.

FIGS. 2A and 2B illustrate a flowchart for implementing a method of processing data for a service business according to one embodiment of the invention.

FIG. 3 illustrates a block diagram illustrating a system for implementing the devices shown in FIGS. 1A and 1B.

FIG. 4 illustrates a flow chart demonstrating a method of associating party and communication point data according to one embodiment of the invention.

FIG. 5 illustrates a flow chart demonstrating a method of associating party and communication data with one another, according to one embodiment of the invention.

FIGS. 6A and 6B illustrate a block diagram illustrating elements of a communication point subject area, according to one embodiment of the invention.

FIG. 7 illustrates a flow chart demonstrating a method of formatting communication point data, according to one embodiment of the invention.

FIGS. 8A and 8B illustrate a flow chart demonstrating a method of formatting communication point data, according to one embodiment of the invention.

FIGS. 9A and 9B illustrate a flow chart demonstrating a method of formatting postal communication point data, according to one embodiment of the invention.

### DETAILED DESCRIPTION

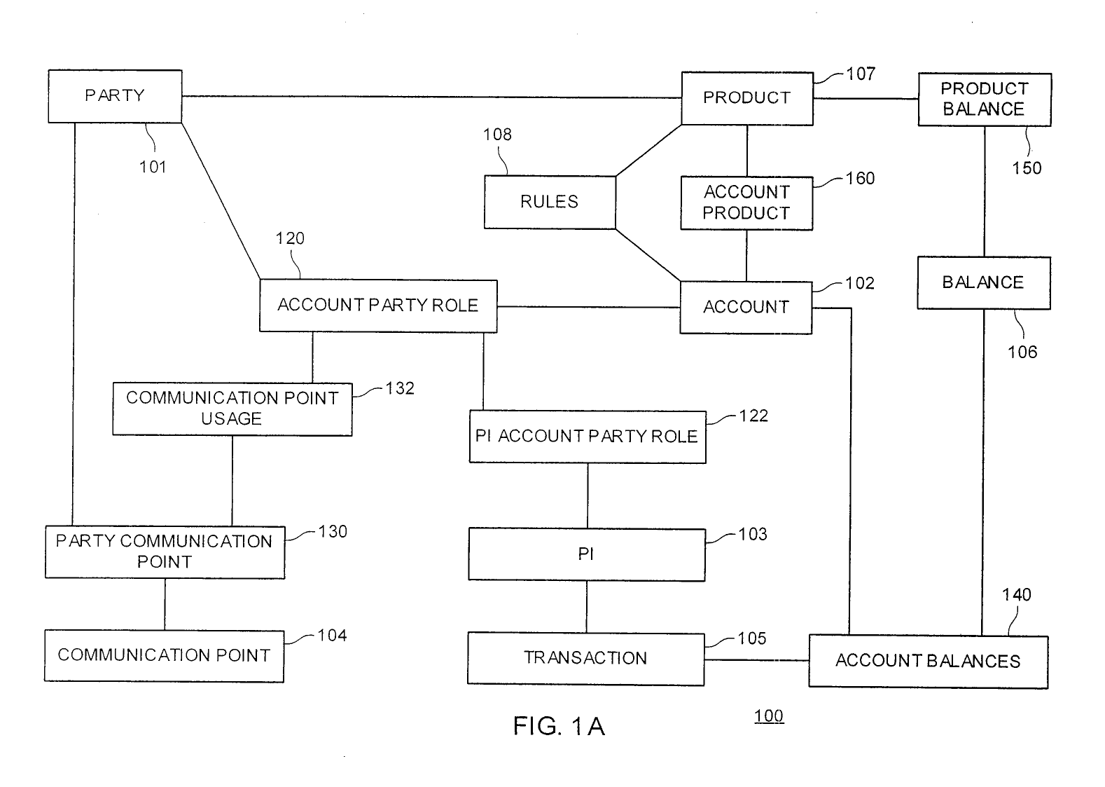

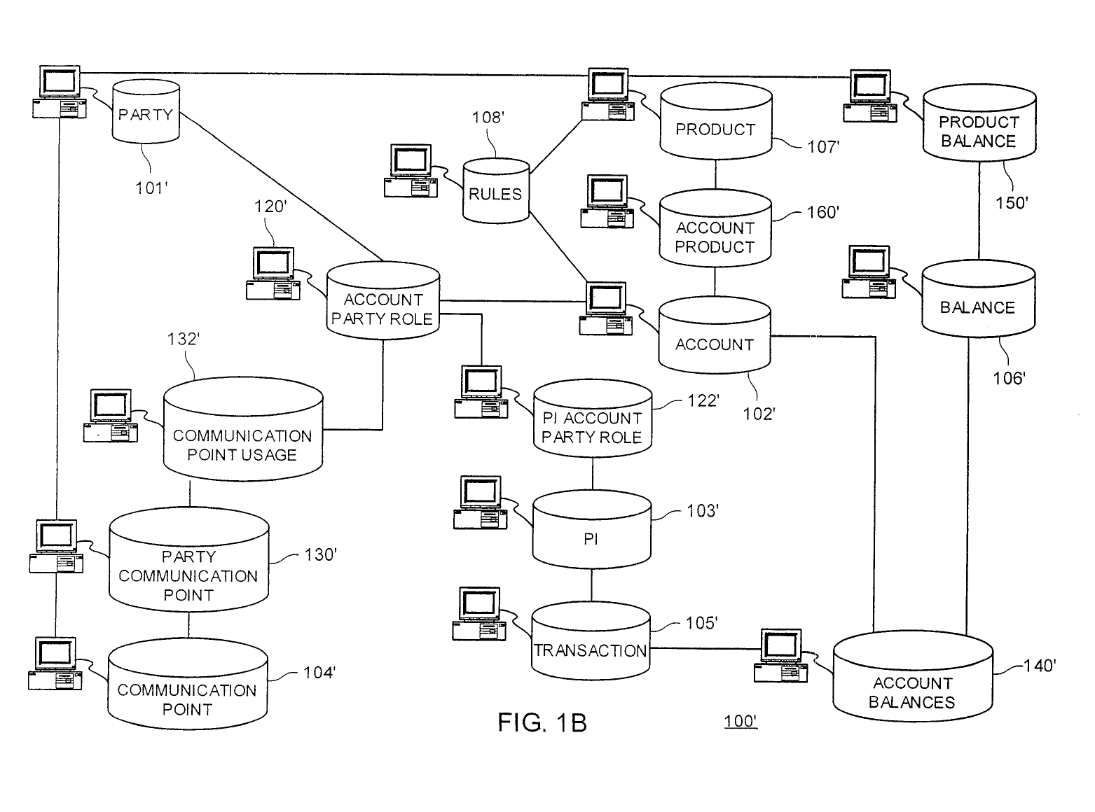

Referring now to FIG. 1A, a data architecture for implementing an embodiment of the invention is shown. Namely, in FIG. 1A, a data architecture is shown that is divided into eight different subject areas, relationships between the subject areas, and the resulting associations between them. For example, FIG. 1A illustrates in system 100 the following subject areas: party 101, account 102, presentation instrument 103, communication point 104, transaction 105, balance 106, product 107 and rules 108. Furthermore, between subject areas, different associations are shown. For example, between party 101 and communication point 104, party-communication point associations 130 is shown. Similarly, between party 101 and account 102, an account-party role association is shown. Furthermore, between presentation instrument 103 and account-party role associations 120, a presentation instrument-account-party role 122 relationship is shown. Similarly, communication point usage 132 is shown positioned between the party-communication point associations 130 and the account-party-role associations 120. FIG. 1A also shows between product 107 and balance 106, the product-balance associations 150. Furthermore, it shows between account 102 and product 107, an account-product associations 160. Finally, between account 102 and balance 106, FIG. 1A shows an account-balance associations 140.

FIG. 1B illustrates a processing system for implementing the data architecture shown in FIG. 1A. Furthermore, each of the subject areas, relationships, and associations shown in FIG. 1A are illustrated by a computer and database in FIG. 1B. A computer and database can be used to store independently the information for each subject area: party 101′, account 102′, presentation instrument 103′, communication point 104′, transaction 105′, balance 106′, product 107′, and rules 108′. In addition, a database and computer can be utilized to store the information for each relationship established between the different subject areas. For example, the database can be used to store internal identifiers from the party database and account database in database 120′ for storing information in regard to an account-party role. Similarly, a database can be utilized to store information for the party-communication point relationship as database 130′. Other databases are shown in FIG. 1B in conformance with FIG. 1A, such as communication point usage database 132′, PI-account-party-role database 122′, account-balance database 140′, account-product database 160′, and product-balance database 150′. Each database is designated in conformance with the architecture shown in FIG. 1A.

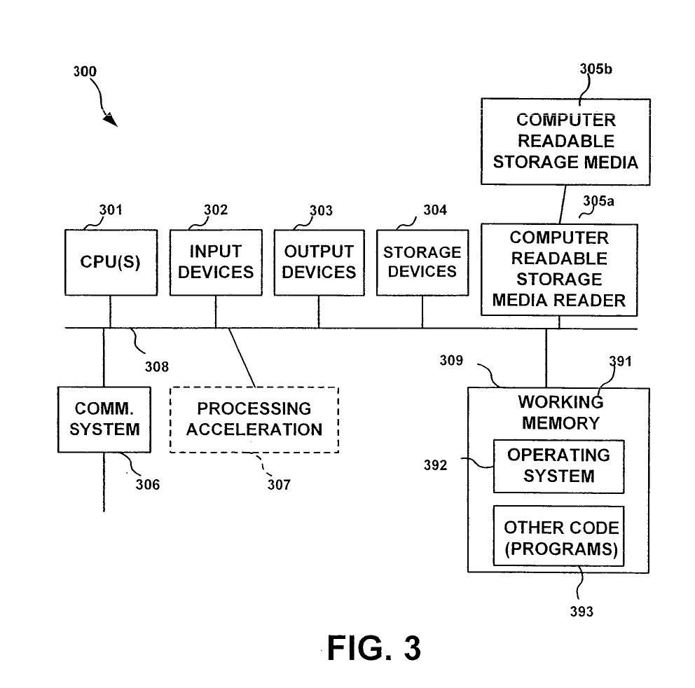

Each of the computers and databases shown in FIG. 1B can be implemented by the exemplary computer system illustrated in FIG. 3. FIG. 3 broadly illustrates how individual system elements can be implemented. System 300 is shown comprised of hardware elements that are electrically coupled via bus 308, including a processor 301, input device 302, output device 303, storage device 304, computer-readable storage media reader 305a, communications system 306 processing acceleration (e.g., DSP or special-purpose processors) 307 and memory 309. Computer-readable storage media reader 305a is further coupled to computer-readable storage media 305b, the combination comprehensively representing remote, local, fixed and/or removable storage devices plus storage media, memory, etc. for temporarily and/or more permanently containing computer-readable information, which can include storage device 304, memory 309 and/or any other such accessible system 300 resource. System 300 also comprises software elements (shown as being currently located within working memory 391) including an operating system 392 and other code 393, such as programs, applets, data and the like.

System 300 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 300 component (e.g. within communications system 306). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) Not all system 300 components will necessarily be required in all cases.

The data architecture shown in FIG. 1A provides a great deal of flexibility for managing data or providing data processing for a service industry. Prior data architectures in the credit card industry, for example, relied upon the referencing of all the information for a customer's account through the use of a single identifier. Similarly, in the utility billing system, all the information for a particular user is referenced as a single set of combined data. The architecture illustrated in FIG. 1A does not reference all of the information for a service by a single identifier for a static record. Rather, it separates information into distinct subject areas. Thus, one is capable of providing a great deal of flexibility to data processing. For example, one can modify the data for a particular party without disrupting processing of that party's account. Essentially, no restructuring of other subject areas is required because an individual subject area can be modified without impacting the other subject areas. Therefore, this type of system provides a great deal of flexibility and functionality that existing systems cannot accomplish.

Referring to FIG. 1A, the various subject areas can be seen. Furthermore, the relationships and resulting associations established between many of the different subject areas can be seen as well. These relationships and associations permit the processing of stored data for desired functionality.

Account

Referring to block 102 of FIG. 1A, the account subject area can be seen. The account subject area is a collection of data about the mechanism used to record, measure, and track financial and non-financial information related to a contractual agreement. Accounts can be characterized by specific components, terms or conditions of data of the service or product that prompted the account's creation. An account can further be characterized by financial and demographic data. Thus, according to one embodiment of the invention, the account facilitates the management, tracking, and reporting of transaction activities. The specific characteristics of an account may vary based on the type of product, product components, party, or terms and conditions established in the contractual agreement.

An account is associated to one or more parties who can use one or more presentation instruments to generate transactions. Furthermore, according to one embodiment of the invention, an account, a party, and a presentation instrument can operate as independent subject areas and can be related in an association to form a unique occurrence of the relationship.

The account subject area provides for the separation of account data from party data and presentation instrument data. Thus, the identity of a party who fulfills a specific business role for a particular account is not stored as part of the account database. Rather, it is kept in the party database and related to the account database where the assigned business role is maintained. Similarly, the data describing the presentation instrument, such as a credit card or smart card, is not stored as part of the account's data. Rather, this information can be related with the account's data by an association database.

An account can participate in one or more relationships with other accounts, for example, as a member of a business group or family group of accounts. Furthermore, multiple presentation instruments can generate transactions for a single account, a group of accounts, or a single member of a group. Thus, a single account could be related with a smart card, a magnetic stripe card, a biometric identifier, etc., each of which could be utilized to initiate a transaction associated with the account.

For example, an individual account associated with several parties can be related with one presentation instrument to generate transactions. Alternatively, a family account with each family member having individual or subordinate accounts can be implemented with the account subject area. Furthermore, a corporate account with one or more dependent accounts could be implemented through the account database. Thus, it is clear that by segregating data for an account, flexibility is provided under the data architecture shown in FIG. 1A.

Party

Referring to FIG. 1A, the party 101 subject area can be seen. The party subject area is a collection of data about individuals, organizations, or organization units that the service provider needs to have information about in order to carry out business operations either directly or indirectly. Parties can be related to other parties as well as to accounts, presentation instruments, balances, products, communication points, and transactions. They can participate in agreements, groups, and organizations. They can act as owners, stewards, contact points, and catalysts of business functions and rules.

For example, customer John Joseph Doe may be known to one client of the data processor as J. Doe, and to another client of the data processor as J. Joseph Doe, Sr. Each client (e.g., Bank One and XCEL Energy) may add a different address for John Doe even though both have the same social security number for him and both know that his birth date was Jun. 10, 1942. The names used by one client of the data processor are not combined with those used by the other clients of the data processor because each is relevant only within the context of the business that provided the information. The party subject area however can store identifying information for the party, such as name and social security number that can be related to many different accounts.

The account to which a party is associated is not stored as part of the party's database. Similarly, the communication point at which a party can be contacted is also not stored as part of the party's database. Rather, the account and/or communication point are related to the party by associative databases.

The party database can provide flexibility to maintain multiple names, statuses, and alternative identifiers for an individual, organization, or organizational unit. It also allows a service organization to manage multiple roles in relationships for an individual, organization, or organizational unit. It further allows one to build and maintain structural relationships between individuals, organizations, and/or organizational units such as peer-to-peer relationships or hierarchical relationships.

Examples of the relationships between parties are customers of a service provider (credit card companies, utility companies, healthcare providers), clients of a data processing system such as receiving banks, vendors, merchants, contacts, business partners, and employees.

Presentation Instrument

Referring again to FIG. 1A, a block 102 entitled “presentation instrument” is shown.

The presentation instrument subject area is a collection of data about physical or virtual devices used as a transaction catalyst to generate transactions, either monetary or non-monetary. The presentation instrument data is stored independently from party and account data in order to facilitate its management. Characteristics of presentation instrument data can be modified without affecting the account or the account status. Presentation instruments are not restricted to being physical devices, such as paper invoices, plastic credit cards, plastic magnetic stripe cards, or smart cards. Rather, they can also be virtual devices, such as a stated account number or an electronic identifier. Any catalyst for initiating a transaction against an account is considered a presentation instrument.

The presentation instrument data can be independently managed. Thus, the presentation instrument data may be related to one or more party/product/account relationships. For example, a party could require reissuance of a “presentation instrument”, such as a credit card, without affecting other credit cards on the same account. Similarly, a virtual presentation instrument could be created for an account to allow the party to enable e-commerce activity without affecting any associated physical presentation instruments.

Communication Point

Another subject area shown in FIG. 1A is communication point 104. The communication point subject area identifies the destination points used for the delivery of communications, e.g., the virtual or physical points where communication(s) can be received. A communication point can be a geographic address; an electronic address, such as an email address; a telecommunication number, such as a telephone or fax number; or any other type of destination point to which a communication can be addressed. Typically, an association will be established between a party and a communication point to describe the relationship of the party to a particular communication point; e.g., one geographic address might be related to a party as the party's home address, another to a party as the party's work address, etc. These associations can be stored in a different database and /or can be used to specify what types of communications can be delivered to them. However, the communication point database stores information about the communication point itself to which relationships are established and various types of communications are sent.

One of the benefits of storing information in a communication point database is that the information can readily be changed when the issuing body changes the content for the communication point. Furthermore, many different communication points can be utilized for a single party by relating the party to those communication points and/or a single communication point can be related to many parties. This provides great flexibility for sending communications to a party depending upon the type of relationship that party has with a communication point and the time at which that relationship is used. Another example of the inherent flexibility is that as business requirements change and new types of communication points are discovered they can be added to the processing system with very little effort.

For example, a communication point could be used to send a specific party the annual statement for a credit card company. The party may only live at its home address for part of the year and live at a different address for another part of the year, as is often the case for retirees. Thus, multiple communication points could be included in a communication point database and an association could be established with the party database to specify the relationship, timing, and usage of the communication point data. These associations can be stored in different databases such as party-communication point database 130 and communication point usage database 132. Thus, the annual statement could be directed to one or more geographic or e-mail addresses during a first part of the year and yet a single geographic address during another part of the year.

One of the benefits of storing information in a communication point database is that the communication point information can change without the relationship to a party changing. Thus, for example, if a district revises the zip code configuration for a city, the zip code for a location can change but the relationship as the primary mailing address will not change. Thus, only the communication point database needs to be updated with the revised zip code information. This can be important in some industries such as the credit card rating industry in which one's credit rating is determined in part by how many times one has moved. The arbitrary redistricting of zip codes, for example, would cause one's address to change, by definition, under the old data processing methods even though the geographic location did not change. Thus, the credit rating rules used to evaluate applicants would consider the change in zip code to be a change in address, causing the credit rating for an individual to worsen—even though the person never moved. However, the system shown in FIG. 1A allows the characterization of the geographic address, i.e., the revised zip code information, to be entered without indicating that the relationship to that geographic location has changed. Thus, under the system shown in FIG. 1A, a post office that revises the zip codes for an individual would not affect the credit rating for that individual. This is yet another example of the flexibility and efficiency of the separation of data brought about by the data processing architecture shown in FIG. 1A.

As another example of the functionality that can be achieved with separated communication point data and unique party-communication point associations, one can envision all the different types of communications that can be sent for a credit card account. Thus, a monthly statement could be directed to a home address for six months of the year and a vacation address for the remaining six months of the year. Furthermore, an overcredit warning could be sent to an email address if one approaches the limit on a credit card. Furthermore, a late payment notice could be faxed to one's home address or a second late notice could be implemented by a telephone call to the individual's home phone. Each of the above communication destinations (i.e. home address, e-mail address, fax, telephone) could easily be altered and stored in the communication point database. However, associations between the party and any “address” in the communication point database can be maintained separately in a database. Thus, in comparison with traditional credit card systems in which a statement, for example, is always sent to the same address, this embodiment of the invention provides greater flexibility for communicating with a party.

Transaction

Referring again to FIG. 1A, the transaction subject area 105 is shown. The transaction subject area stores data relating to transactions conducted for a service. The transaction subject area stores a collection of data about business actions or events that impact implied financial worth or cause movement of funds from one account to another and/or impact non-financial properties (e.g., names, addresses, requests for new plastics). Thus, the transaction database can store information relating to previous purchases for a credit card account, for example. Similarly, it can store utility bill payments or billing statements for a utility service. Essentially, it stores all the data that memorializes transactions that occur for an account. In the case of the credit card industry, many of the service groups such as Mastercard and Visa have a predefined format for storing transaction information. The transaction subject area can understand these external formats, can document them as they are presented, and can broker them into internal format that can be posted to the appropriate balances on an associated account.

Balance

The balance subject area 106 in FIG. 1A is utilized to store balance information for products and accounts. Essentially, a balance is a total maintained by balance type and period for an account or account party role that serves as a mechanism for accumulating financial (debit/credit) activity. Examples of an account balance are the balance due on a utility bill or a credit card bill. This balance information can include the date of the balance, the amount of the balance, etc. The balance database keeps a balance history for each account as desired.

The balance database provides a great deal of flexibility in the types of balances that can be kept for an account. For example, a promotional balance can be used for a new product, such as a new credit card line. A late fee balance can be kept separate for a credit card as well. Similarly, an overlimit balance can be kept for an account. In addition, a big ticket promotional balance can be utilized for an account. Such promotional balances might include how much one pays toward a specific product such as a refrigerator. Thus, if a special promotional program is in existence for refrigerators, for example, the balance database can store how much money has been applied towards purchases which trigger the grant of the reward towards the refrigerator.

Thus, the balance database provides for all different kinds of balance information to be kept that can be utilized for an account or specified for a particular product line. It provides great flexibility in that the balance information can be varied and different balances can be selected for a product line.

Product

The product subject area 107 is a collection of data about a named item or service intended for sale by one party to another party for the purpose of generating revenue. Thus, parties who participate in product campaigns typically take on different roles such as those who offer products to market, those who service a product, and those who use the services provided by the product. As an example of those who offer a product to market, an issuing bank which issues credit cards to customers is one example. Similarly, a money transfer agent such as Western Union, which offers money transfer services to parties, is another example. Similarly, companies that operate as third parties for issuing and acquiring banks, such as First Data Resources and First Data Merchant Services, fall into this category as well. As an example of those who service a product, First Data Resources or any other third party processor is an example of one who performs this service. Finally, as an example of those who use the services provided by the product, a consumer using a credit card is an example of that category.

Products can be defined by party-selected component data. This replaces program-implemented features and functionality. Thus, an issuing bank party can select the components that it wishes to include as part of a new product to be offered to the purchasing public, each of which would be a separate party. This allows the issuing bank, for example, to select the interest rate, credit line, payment options, etc.

Another example of a product is a utility service. Thus, the rate for gas and electricity can be defined separately. In addition, the late fees can also be defined as separate components. The party offering such a product in this example would be the utility company while the homeowners would be the consumers.

Typically, a product will define the hierarchical nature of components, such as rollup balance, and summary statements. It can also define account balances, such as promotional balances and fees. Furthermore, it can define the treatment of those balances. In addition, it can define how the balances are affected by transactions, such as sales, payments, reversals, etc.

Products can vary by different lines of business, such as credit, retail, e-commerce, cellular, etc. A product will typically organize component data in such a way that a business person can use them, a client can understand them, and an application can process them. This allows an unlimited number of components to define a party's product. Furthermore, it allows a faster time to market for new products or to make changes to existing products. Furthermore, it provides a centralized and easily accessible database for product definitions.

Examples of products are a merchant service; a funds transfer service; a Visa™ Platinum with reward feature; a Mastercard™ Gold Card account; a retail card; an investment cash management service; a cellular transaction/billing account; and an electric utility billing service.

Rules

The final subject area illustrated in the architecture shown in FIG. 1A is the rules 108 subject area. The rules subject area is a set of data used to provide a decision and action infrastructure. A client of the service provider or the service provider itself can give a rule a definition of an action enabler within which it manages its business. Detection of business events can trigger party-defined business logic managed within the rules subject area. The rules subject area manages processing controls comprised of business logic and parameters that are translated into executable code.

Thus, the rules database 108 can be utilized throughout the processing system depicted in FIG. 1B and FIG. 13 and to support the associations between other subject areas. For example, in the communication point usage database 132, rules can be invoked to determine when a particular party should be contacted at a communication point triggered by a business event. The rules database can be invoked to trigger a decision and resulting action depending on the formatting of the rule.

One example of use of the rules database would be as follows:

If customer's state is “CA” and the transaction is an ATM cash advance, perform

CASH FEE 1

Action Set: calculate 4% of the transaction amount

Add $1.00 to the previous result

Assess the amounts

Otherwise, if the transaction is an ATM cash advance, perform

CASH FEE 2

Action Set: calculate 4% of the transaction amount

Assess the amount.

Subject Area Associations

The various subject areas have been described above as independent databases for storing information related to a service business. Relationships exist between the different subject areas and different components within the subject areas. These relationships result in associations that can be configured as databases for storing relational information between the subject area databases. While independent databases are typically used to describe the sets of data for different subject areas, it is also envisioned that separate databases could be used to store information for more than one subject area and the associations between them.

Block 130 in FIG. 1A shows a party communication point associative database. The party communication point associative database includes a grouping of data related to the party 101 database and communication point 104 database so that entries from each of those databases can be linked or coupled with one another. This allows information from the party and communication point databases to be associated so that the data stored separately can be put to use. One way to accomplish this is by associating an internal identifier for an entry from the party database 101 with an internal identifier for an entry from the communication point database 104 as an entry in the party-communication point database. Yet another internal identifier can be coupled with these two ID's, used to indicate the type of association that has been created, to form a unique entry. However, this is not necessarily required as the grouped internal identifiers can be identified and then their associated information can be obtained from the appropriate subject area database. In other words the association between the two identifiers is that the first internal identifier represents the subject and the second internal identifier represents the object of the relationship. Thus, the internal identifier for the communication point could be the subject and the identifier for the party could be the object so as to indicate that: “This specific communication is the home address for this specific party.”

Thus, the architecture shown in FIG. 1A illustrates that a service business can be broken into different individualized subject areas. These subject areas can be kept separate from the other subject areas to allow the management of the information stored for each subject area separate and distinct from the management of the other storage area data. This permits a great deal of flexibility in the manipulation of data for a particular subject area.

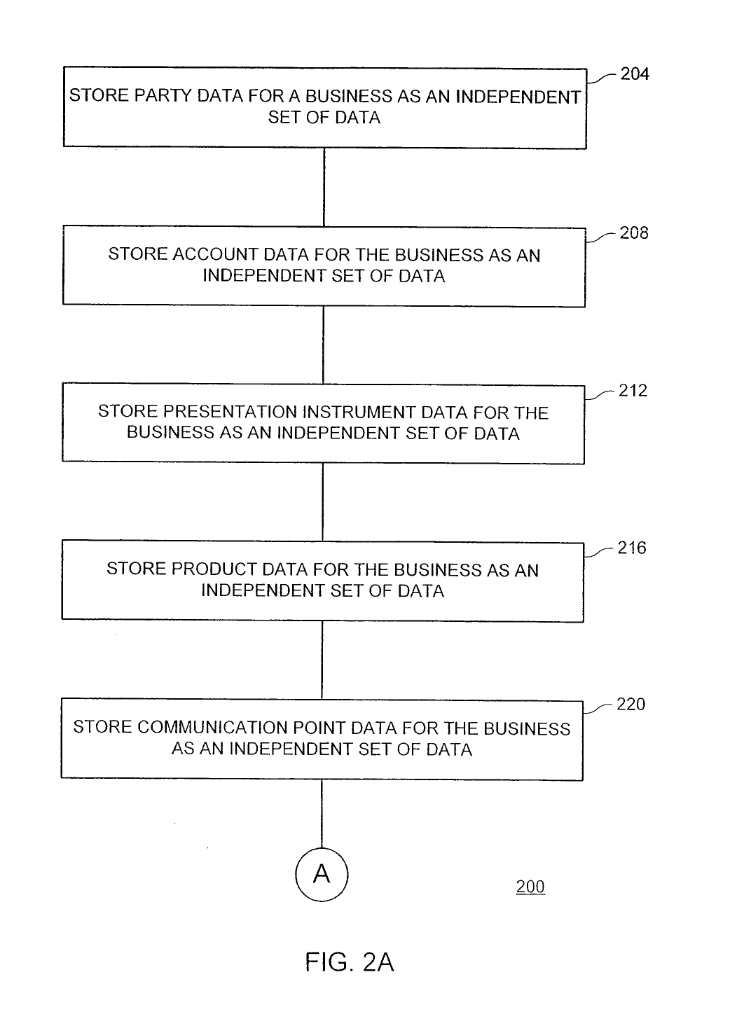

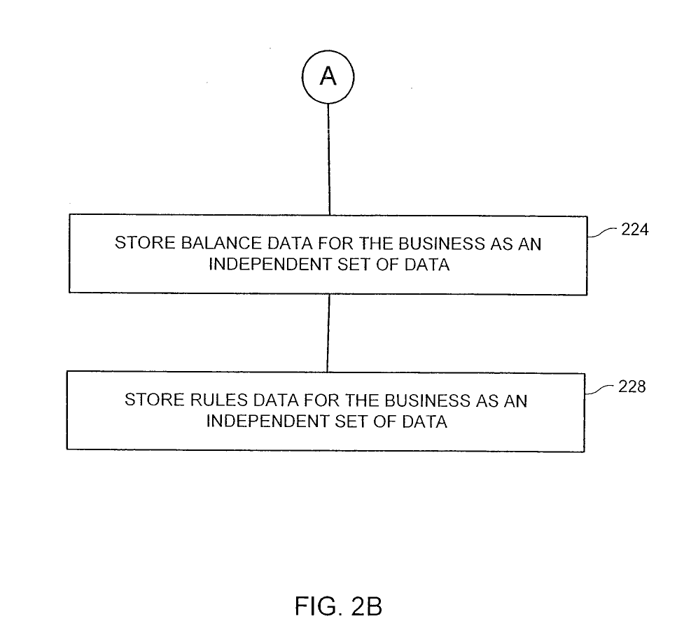

FIG. 2A illustrates the principle of dividing the architecture into separate subject areas. Namely, in flowchart 200 of FIGS. 2A and 2B, party data can be stored for a business as an independent set of data in block 204. Furthermore, in block 208, account data can be stored for the business as an independent set of data. Similarly, presentation instrument data for the business can be stored as an independent set of data in block 212 and one can store product data for the business as an independent set of data in block 216. Communication point data can be stored as an independent set of data in block 220, while balance data for the business can be stored as an independent set of data in block 224. Furthermore, rules data for the business can be stored as an independent set of data in block 228.

Party-Communication Point

FIG. 1A illustrates another relationship between two subject areas, namely the relationship between the party subject area and the communication point subject area. A party-communication point database can be established to define the relationship that an individual, organization, or organization unit has with a type of communication point. Thus, this allows one to establish whether the type of association is a home, employer, temporary, return address, etc regardless of the communication point type (geographic, electronic, telephonic, etc.).

This database of the party-communication point information is useful in that it allows a service provider to understand how many of their service users have a relationship with the same communication point for marketing and cost-reduction purposes. For example, a credit card company can determine how many letters it is sending to the same communication point with advertisements. If a family of card holders resides at the same address, multiple mailings may be sent there inadvertently when one would suffice. Similarly, billing statements could be combined for the same party who has multiple accounts but is located at one communication point.

TABLE A

| | INTERNAL | RELATIONSHIP | COMM | COMM | INTERNAL |
|---|---|---|---|---|---|
| PARTY | PARTY ID | TYPE | POINT ID | TYPE | COMM PT. ID |
| Joe Smith | 0001 | Home | CP123456789 | Geographic | H0001 |
| Mary Smith | 0002 | Employer | CP787663524 | Geographic | H0002 |
| Mary Smith | 0002 | Home | CP123456789 | Geographic | H0001 |
| Acme Accounting | 0003 | Return Address | CP918273764 | Geographic | H0003 |
| Officer Grear | 0004 | Employer | CP567891234 | Geographic | H0004 |

Table A illustrates an example of a relationship of information that can be identified by a party communication point database. An entry is shown for the party Joe Smith and communication point ID CP123456789. This entry further indicates the association between the communication point and Joe Smith as home and that it is a geographic communication point. Table A further illustrates the fact that the communication point with identifier CP123456789 is used by both Joe and Mary Smith as their home address.

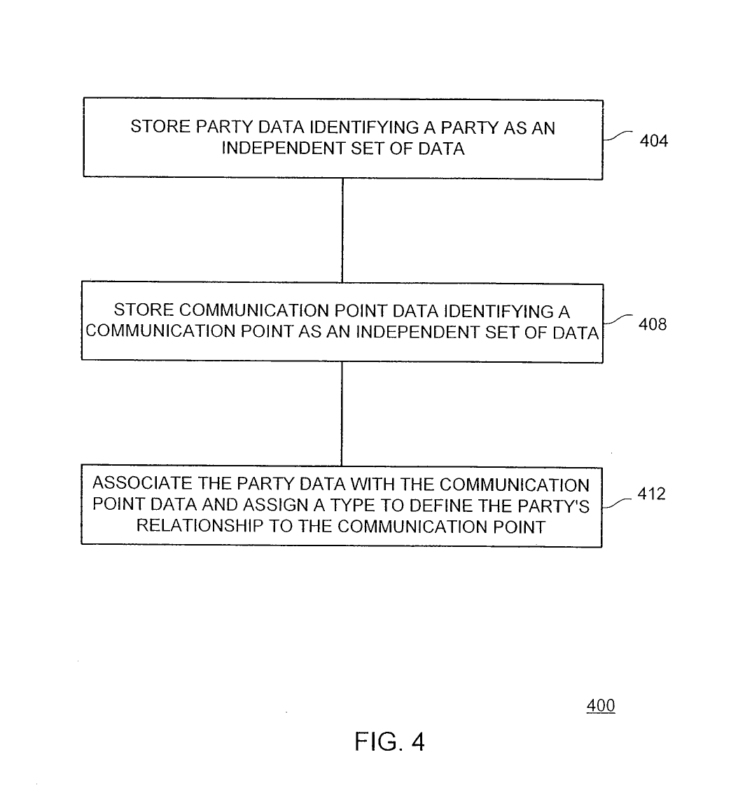

Referring now to FIG. 4, flowchart 400 illustrates a method of implementing a party communication point database. In block 404, party data identifying a party is stored as an independent set of data, such as in party database 101. In block 408, communication point data identifying a communication point is stored as an independent set of data, such as in communication point database 104. In block 412, the party data is associated with the communication point data and the association is assigned a type.

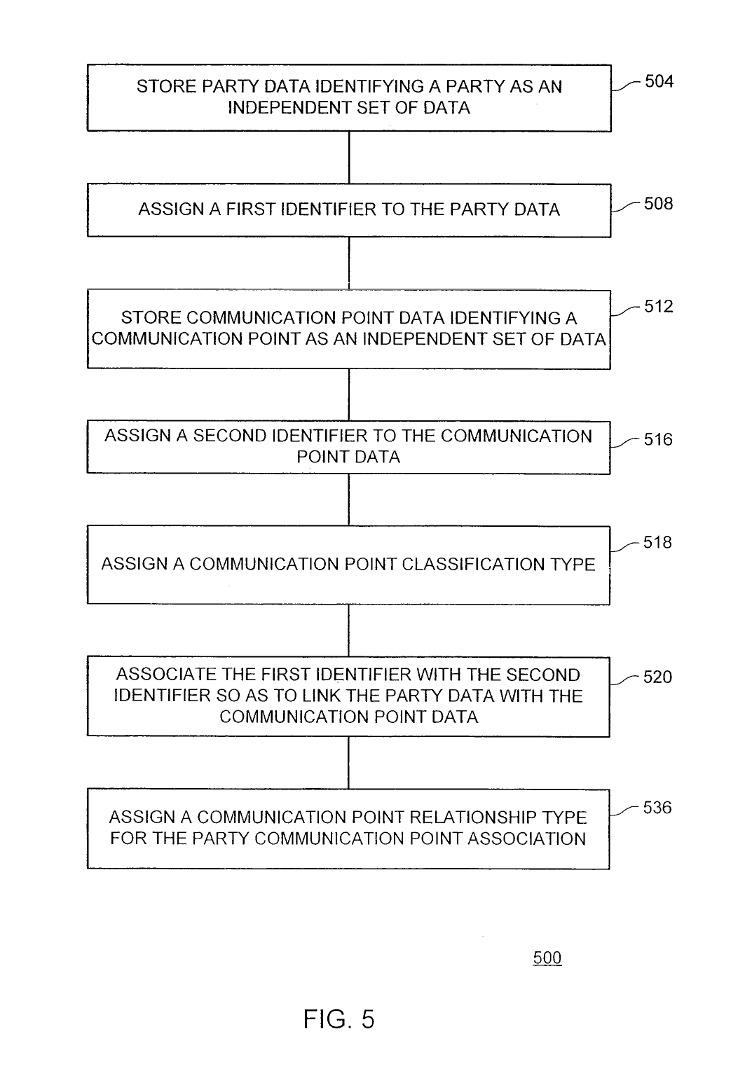

A further example is shown in FIG. 5. In block 504 of flowchart 500, party data identifying a party is stored as an independent set of data. In block 508, a first identifier is associated with data for a specific party. In block 512, communication point data identifying a communication point is stored as an independent set of data. In block 516, a second identifier is associated with the data for the communication point. In block 518, a communication point classification type is assigned to the communication point data entry. In block 520, the first identifier is associated with the second identifier as a single data entry so as to relate the specific set of party data with the specific set of communication point data and so as to identify the communication point as being assigned to the party. In block 536, a communication point relationship type is assigned to the association for the specific set of party data and the specific set of communication point data. This can be accomplished by storing the first identifier, second identifier, and communication point relationship type as a set of data stored on the party communication point type database. Thus this allows the party information to be stored and managed independently from the communication point data while still establishing a relationship between the two data entries.

Communication Point Usage

Referring now to Table B, the relationship of communication point usage can be better understood.

TABLE B

| PARTY | ROLE | ACCOUNT TYPE | ACCOUNT ID |
|---|---|---|---|
| Joe Smith | Guarantor | Revolving Credit | RC123456789 |
| Joe Smith | Guarantor | Revolving Credit | RC123456789 |
| Mary Smith | Authorized | Revolving Credit | RC123456789 |
| | User | | |
| Mary Smith | Payor | Electric Utility | U987654 |
| Acme Accounting | Accountant | Revolving Credit | RC123456789 |
| Officer Grear | Fraud | Revolving Credit | RC567891234 |
| | Investigator | | |

USES

| | RELATIONSHIP | | |
|---|---|---|---|
| PARTY | TYPE | COMM POINT ID | COMM TYPE |
| Joe Smith | Home | CP123456789 | Geographic |
| Joe Smith | Home | CP123456789 | Geographic |
| Joe Smith | Home | CP123456789 | Geographic |
| Mary Smith | Employer | CP787663524 | Geographic |
| Acme Bank | Return Address | CP918273764 | Geographic |
| Officer Grear | Employer | CP567891234 | Geographic |

### Usage Type

Plastics

Statements

Letters

All Communications

Statement

Fraud Contact

The communication point usage relationship allows a party communication point to be associated with an account party role. The account party role entries indicate the role that a specific party will play on an account. The party communication point indicates a communication point for a particular party. By linking entries for the party communication point and the account party role, a specific usage can be added as well. Thus, a type of communication can be indicated. Table B illustrates three sets of data, the party/communication point data, and the party/account role set of data, and usage types for these cross-referenced entries. For example, the first entry in the party/account role database is for Joe Smith as guarantor on an account. Furthermore, the first entry in the party/communication database is for Joe Smith's geographic home location. The first entry for the usage type is plastics. Thus, Table B illustrates that any communications relating to plastics, such as new credit cards, are sent to Joe Smith at his geographic home address. Similarly, the second entry in each of the three sets of data indicates that statements are sent to Joe Smith as guarantor to his home geographic address. The third entry indicates that any letters for Mary Smith in her role as authorized user on the revolving credit account RC123456789 are to be sent to Joe Smith's home geographic address. However, the fourth entry indicates that any communications to Mary Smith in her role as the payor for electric utility account U987654 are to be sent to Mary Smith's employer's geographic address. The fifth entry indicates that any statement communication for Acme Accounting as accountant on revolving credit account RC123456789 are to be sent to the geographic return address entry for Acme Accounting identified by communication point ID CP918273764. The sixth entry indicates that any fraud contacts for revolving credit account RC567891234 should be sent to Officer Grear in his role as fraud investigator at his employer's geographic address indicated by communication point ID CP567891234.

The example of Table B indicates that, once entries are established in different relationship databases, they may be combined for further relationships. Thus, an entry in the account party role database 120 can be associated to an entry in the party communication point database 130 to establish a communication point usage entry in communication point usage database 132. Again, internal identifiers can be associated with each entry in the account party role database and the party communication point database to associate instances (i.e., data) from each of those databases. Furthermore, each of those associations can include additional information such as the usage type (plastics, statements, letters, all communications, return address, fraud contacts, etc.) for that particular entry.

Communication Point Subject Area

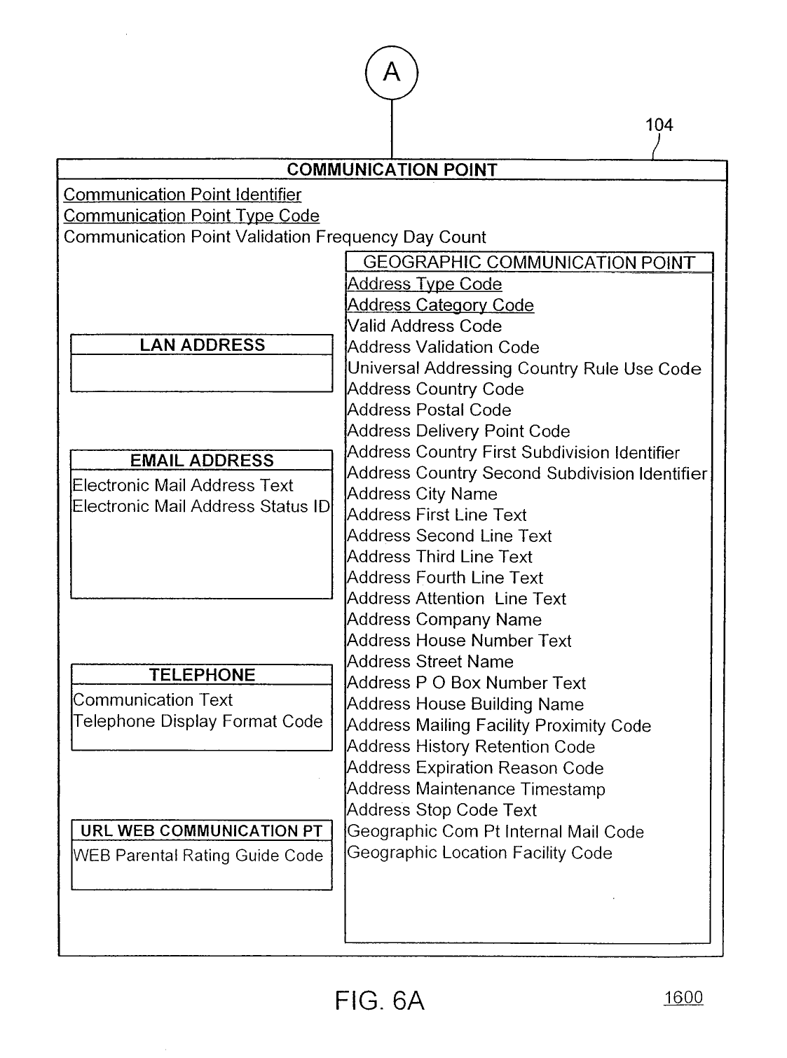

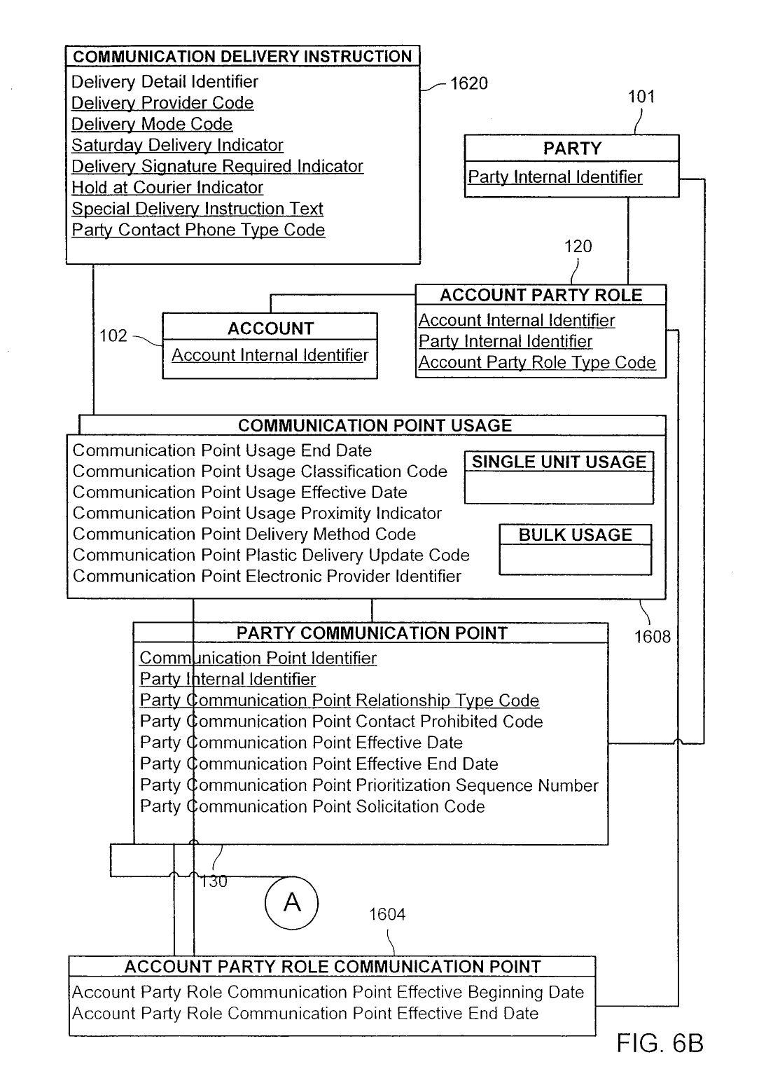

Referring to FIGS. 6A and 6B, block 104 shows the Communication Point database components. A communication point is a way in which a party can be contacted. For example, a communication point can be a geographic address, a LAN address, an email address, a telephone number, a fax number, or a URL web communication point depending on the type code associated with it. The communication point data defines the communication point. An internal identifier generator can be utilized to generate internal ID's for each entry in the communication point database. It is then related to other subject areas such as party information using that internal ID. In this way, the communication point data can be kept separate from the party and the same communication point may be associated with many parties. Furthermore, it can be updated without affecting the other subject areas.

A geographic communication point can be specifically defined by a data entry which can include: an “Address Type Code”, an “Address Category Code”, a “Valid Address Code”, an “Address Validation Code”, a “Universal Addressing Country Rule Use Code”, an “Address Country Code”, an “Address Postal Code”, an “Address Delivery Point Code”, an “Address Country First Subdivision Identifier”, an “Address City Name”, an “Address First Line Text”, an “Address Second Line of Text”, an “Address Third Line of Text”, an “Address Fourth Line of Text”, an “Address Attention Line Text”, an “Address Company Name”, an “Address House Number Text′, an “Address Street Name”, an “Address PO Box Number Text”, an “Address House Building Name”, an “Address Mailing Facility Proximity Code”, an “Address History Retention Code”, an “Address Expiration Reason Code”, an “Address Maintenance Timestamp”, an “Address Stop Code Text”, a “Geographic Communication Point Internal Mail Code”, and a “Geographic Location Facility Code”. Not all of these fields need to be defined in order to define a geographic communication point.

Similarly, a LAN address entry can be defined by appropriate data such as for IPv4 or IPv6. Furthermore, an email address can be defined with “Electronic Mail Address Text” and “Electronic Mail Address Status Indicator”. A telephone number can be defined with “Communication Text” and a “Telephone Display Format Code”, as yet another example.

A more detailed view of the interaction between the account, party, and communication subject areas can be seen by referring to FIGS. 6A and 6B. FIGS. 6A and 6B illustrate a system 1600 for implementing these interactions. In FIGS. 6A and 6B, the Party information database 101 is shown associated with data from the Account database 102 to establish the Account-Party Role relationship database 120. Similarly, the Party database 101 is shown associated with the Communication Point database 104 to establish the Party Communication Point relationship database 130.

The Party Communication Point relationship database 130 receives internal identifiers from both the Party database and the Communication Point database to establish an associative relationship between the entries associated with those internal identifiers. Thus, a communication point for a particular party is established. Associating Party and Communication Point in this manner allows a great deal flexibility and simplified communication point management. For example a single communication point can be related to many parties and a single party can inform the service provider of many different communication points, of varying types, that can be used to communicate with it. All communication points are typically created and regulated by some issuing body (Geographic—Local Governmental Agencies, Electronic—Internet Service Provider, Telephone—Telephone Service Provider, etc.) which periodically dictates maintenance changes (i.e. zip code changes, street name changes, area code changes, etc.). The implementation of mandated changes is easily accomplished due to the fact that each communication point occurs only once in the system. Additional information can also be added to this associative relationship. For example, FIGS. 6A and 6B illustrate that data for the Party Communication Point can include:
1) A ” Party Communication Point Contact Prohibited Code” to indicate whether that communication point may be used to contact a party;
2) a “Party Communication Point Effective Date” to indicate the date upon which the communication point becomes active for that party and therefore can be used by the service provider to communicate with it;
3) a “Party Communication Point Effective End Date” to indicate the date upon which the communication point is no longer valid for that party and therefore cannot be used by the service provider to communicate with it;
4) a “Party Communication Point Prioritization Sequence Number” used to prioritize the possible means of communicating with a customer;
5) a “Party Communication Point Relationship Type Code” which is a code that represents the Party's view of their relationship to a specific communication point at a specific point in time, e.g., “HOME” for a home address, “EMPL” for an employer's address, “TMVA” for a temporary vacation address, and “BUSN” for a business;
6) a “Party Communication Point Solicitation Sode” which can be used to determine privacy preferences for a party communication point.

These data fields allow a great deal of functionality to be accomplished with the architecture beyond that which can be accomplished with traditional systems. For example, with the “Party Communication Point Contact Prohibited” field, one can completely bar contact with the party at that communication point—for example, don't email me at my home email address.

Similarly, by providing effective dates for a communication point, a great deal of flexibility can be established in regard to where and when communications may be sent to a party during the year. For example, billing statements can be sent to a party at a vacation home communication point in Arizona during the winter months and sent to a home address in Nebraska during the remainder of the year. The “Party Communication Point Effective Date” and “Party Communication Point Effective End Date” would be used to determine when the billing statements, for example, can be sent to the Arizona address. A second entry in the Party Communication Point relationship database would be used to determine when the communication can be sent to the Nebraska address.

The “Party Communication Point Solicitation Code” can be used to indicate whether the party can be solicited at that communication point. With the enactment of new privacy legislation, it is beneficial for service providers to be able to track whether the party can be solicited at a particular communication point. This “solicitation code” field in the Party Communication Point relationship database can thus be used to determine whether the party has opted in for solicitation; or alternatively, it can be used to determine whether the party has opted out of being solicited under a different configuration. Under either configuration, the party's preferences can be tracked. For example, under an opt-in configuration, the field might initially be set to “no solicitation” as a default until the party affirmatively opts in and the field is changed to reflect that fact.

While the Party Communication Point relationship database 130 associates a particular party with a particular communication point, instruction is still required as to what data or tasks are to be directed to that party at that communication point. This function can be accomplished by the interrelationship between the communication point usage database 1608, account party role database 120, and the party communication point database 130.

The communication point usage database can be used to define the types of correspondence that are produced that can be sent to a communication point. For example, it can include a “Business Process Output Type Code” to represent the type of correspondence sent to a party. Examples of this type code include “BLL1” for billing correspondence, “PLST” for correspondence relating to plastics (e.g., plastic credit cards), “MALR” for plastic mailer, and “LTTR” for letters, “STMT” for statements.

Another example of a field accessible through Communication Point Usage database 1608 is a “Paper Stop Effective Date”. This field stores the date that the customer indicated it was acceptable to stop generating correspondence in the form of paper. Thus, this helps to satisfy laws that require that paper statements be sent unless the customer indicates that such paper statements do not need to be sent—in lieu of on-line access or electronic mailings, for example.

Another field that is accessible through the Communication Point Usage database 1608 is the “Business Process Output Generation Media Code”. This code determines how output related to a business function will be generated. For example, the following codes could be used, where “Y” is the default code:
“Y” =electronic and paper will be produced;
“N” =paper will not be produced;
“L” =electronic and paper will be produced, paper should be turned off.

The Communication Point Usage database 1608 itself helps to define delivery instructions for correspondence that could be communicated to a Party that has a role on an Account. For example, the following fields can be used: “Communication Point Usage End Date”, “Communication Point Usage Classification Code”, “Communication Point Usage Effective Date”, “Communication Point Usage Proximity Indicator”, “Communication Point Delivery Method Code”, “Communication Point Plastic Delivery Update Code”, and “Communication Point Electronic Provider Identifier”.

The “Communication Point Usage end Date” is the date that a communication point is no longer effective for an account party role and business process. The communication point usage classification code is the period of time that the communication point will be used. This field is used in conjunction with the “Correspondence Type Code” to determine which address within a specific correspondence type code will be used to deliver correspondence. For example, the following values can be used: “P” for permanent, “R” for repeating, indicating that the address applies for a recurring and specific time period, “T” for temporary, indicating that the address is effective for a short time period, usually in the context of sending a replacement plastic to a vacation address.

The “Communication Point Usage Effective Date” is the date that a communication point is effective for an account party role and business process. The “Communication Point Usage Proximity Indicator” is the value used to determine if the communication point and the mailing facility are in the same country when used for an account party role and business process. The “Communication Point delivery Method Code” determines how the plastic will be mailed to the customer (e.g., first class mail, Airborne, FedEx, registered mail, or certified mail). The “Communication Point Plastic Delivery Update Code” is a code that determines the process available to the issuer for changing the mail code. Finally, the “Communication Point Electronic Provider Identifier” can be an identifier for an electronic correspondence provider (e.g., “5001”=“Billpay.com”).

Also shown in block 1608 are sub-unit blocks labeled “Bulk Usage” and “Single Unit Usage”. Coupled with the “Bulk Usage” block is an external Bulk Mail block 1616. This block helps to further define bulk mailing functions, such as when plastics for a group of people are first sent to an intermediary. The intermediary can perform a check of the individual envelopes in which the individual plastics are enclosed before depositing the individual envelopes in the mail. Another example of bulk mail delivery is where a group of envelopes are sent to an intermediary when the local postal service is unreliable (for example, in third world countries). The Bulk Mail block 1616 includes fields for a “Bulk Mail Identifier”, a “Bulk Mail Descriptive Text”, a “Bulk Mail Sealed Envelope Indicator”, and a “Bulk Mail Metered Mail Indicator”.

Communication Delivery Instructions block 1620 helps define further delivery instructions that can be assigned to a specific business process output type of communication for a specific party playing a role on an account by providing fields for a “Delivery Detail Identifier”, a “Delivery Provider Code”, a “Delivery Mode Code”, a “Saturday Delivery Indicator”, a “Delivery Signature Required Indicator”, a “Hold At Courier Indicator”, a “Special Delivery Instruction Text”, and a “Party Contact Phone Type Code”.

Also shown in FIGS. 6A and 6B is the Account Party Role Communication Point relationship database 1604. This relationship database establishes an associative relationship between entries in the Account Party role database 120, the Communication Point Usage database 1608, and the Party Communication Point database 130. The association with the Communication Point Usage block 1608 allows the service provider to establish the information needed to send a specific piece of communication to a specific party playing a role on an account at a communication point with which a relationship has been established to any party playing a role on that account. In addition to storing internal identifiers from the account party role database and the party communication point database, the account party role communication point database also stores the fields of “Account Party Role Communication Point Effective Beginning Date” and “Account Party Role Communication Point Effective End Date”. These fields allow the beginning and ending dates to be defined for communicating with a particular party playing a particular role on a particular account.

When data is grouped for a communication point, i can be updated expeditiously. Furthermore, it can be formatted according to a desired format—such as a format mandated by a regulatory agency. The formatting can be applied to the communication point data without requiring that the communication point data be stored in a way that is dependent upon the regulatory agency. Thus, a set of communication point data can be maintained separately and multiple formats can be applied to the same set of communication point data to achieve different formatting. For example, different postal systems prefer different formatting of addresses used on letters. In some instances, a data processor may desire to address a letter according to the US postal format while in other instances the data processor may desire to address a letter in the Canadian format. Namely, since postal services often give discounts to mass mailers if the correct postal format is implemented, a data processor can save money by applying the format that will produce the greatest financial benefit.

Furthermore, as formats change, the formatting can be revised without requiring that multiple records be updated. For example, if a postal service moves to a 10 digit zip code as opposed to a 5 digit zip code, that format can be implemented without revising all of the communication point data sets.

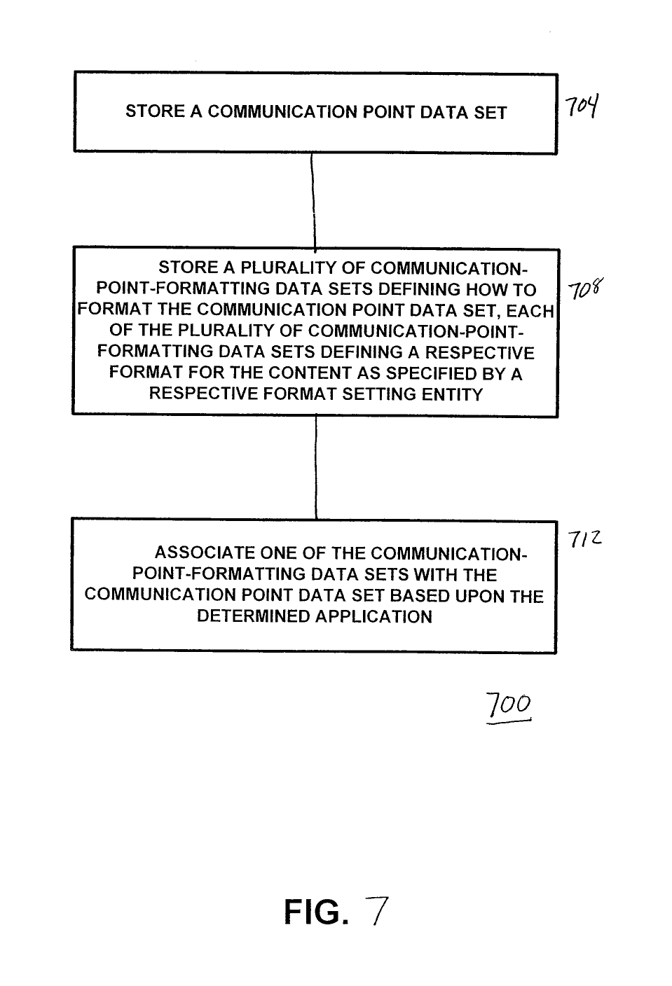

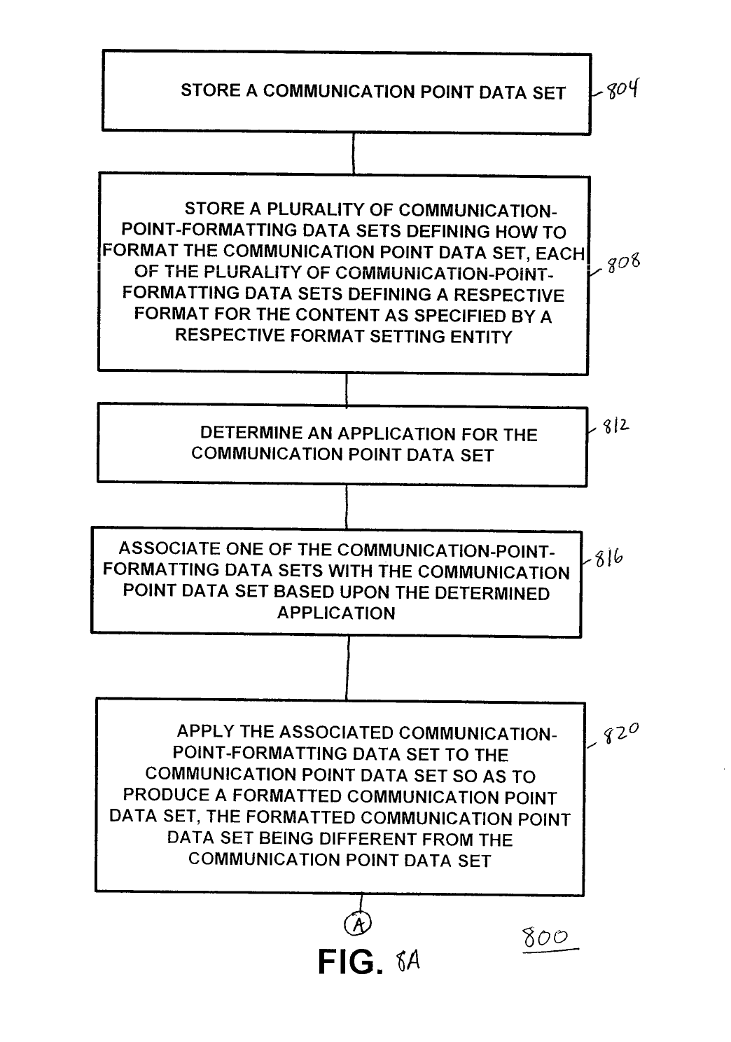

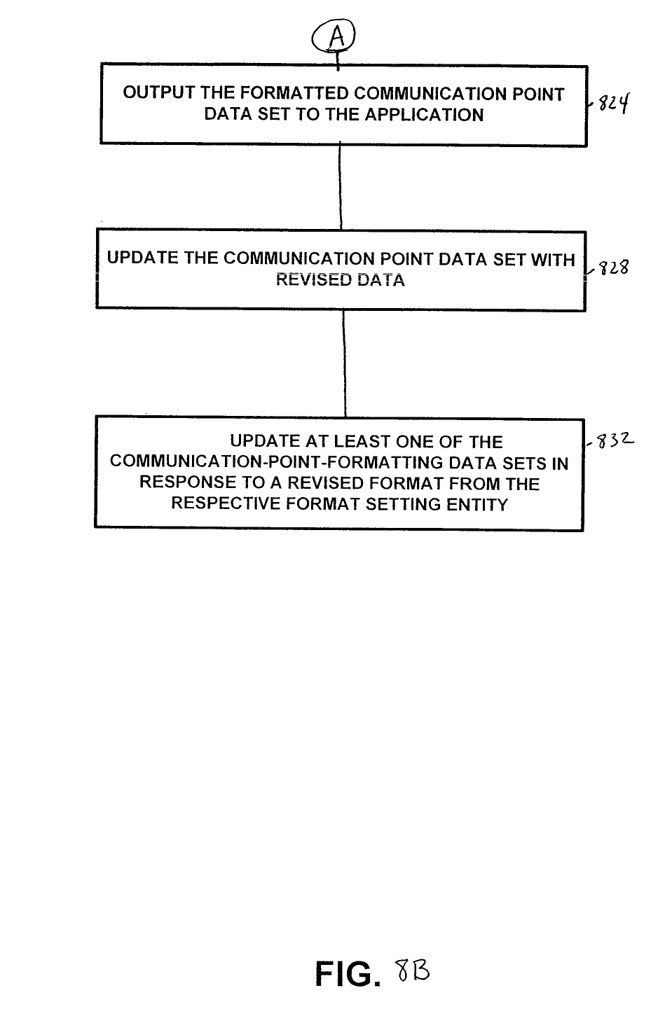

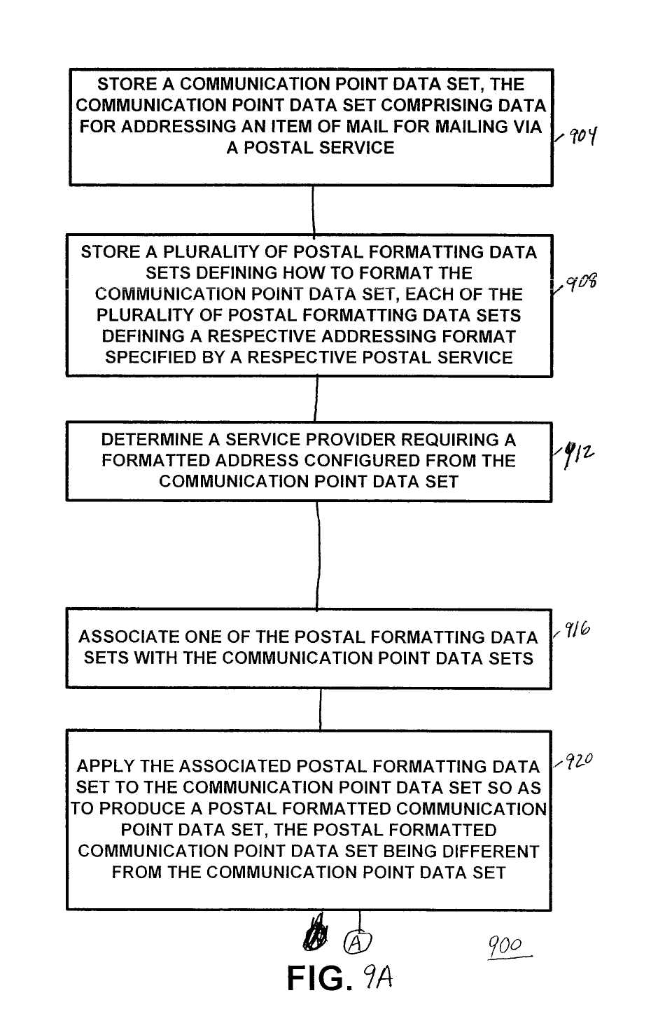

FIG. 7 illustrates a flow chart 700 demonstrating a method of formatting communication point data, according to one embodiment of the invention. In block 704, a set of communication point data is stored. This set of communication point data can be a comprehensive set of data that includes geographic address data, GPS data, LAN data, telephone numbers, fax numbers, and email addresses. In block 708, multiple communication-point-formatting data sets are stored. These communication-point-formatting data sets define how to format a communication point data set. Furthermore, each of the communication-point-formatting data sets can be specified by a respective format setting entity. Thus, multiple postal services from different countries can specify how they prefer to have mail in their country addressed. Thus, the data processor that is addressing mail to a particular country can properly format the address to the foreign country's addressing scheme and not necessarily to a default standard, such as the US addressing format. While postal services are used as the example, different regulatory agencies could apply, as well. For example, an international telephone scheme could produce a format that applies to making international calls. A regulatory agency that specifies how GPS data should be formatted, can specify an appropriate format, as well, for example. In block 712, a particular communication point data set can be associated with a particular communication-point-formatting data set. By associating the two data sets with one another, the service provider can properly format the communication point data in accordance with the associated format. Furthermore, this can be accomplished while still maintaining the communication point data set in an undisturbed form so that a different format could be applied at a successive point in time.

Referring now to FIGS. 8A and 8B, a flow chart 800 illustrates a more detailed example of formatting communication point data according to one embodiment of the invention. Namely, in block 804, a communication point data set is stored. In block 808, multiple communication-point-formatting data sets are stored. These communication-point-formatting data sets define how to format communication point data sets. Each of the communication-point-formatting data sets is defined by a respective respective format setting entity—e.g., a regulatory agency. In block 812, an application for the communication point data set is determined. For example, the application could be a bulk mailing being performed by a data processor on behalf of a credit card company. In block 816, one of the communication point data sets is associated with one of the communication-point-formatting data sets. Furthermore, this association can be implemented based upon the determined application. Thus, if a bulk mailing of credit card statements through the US mail is being implemented, the communication point data set can be associated with the US postal service mailing format that allows a bulk mailer to obtain a postage discount. However, if the data processor has an affiliate in a foreign country and the bulk mailing is being sent to parties located in that foreign country, then the communication-point-formatting data set for that foreign country's postal format could be selected instead. In block 820, the formatting criteria from the communication-point-formatting data set is applied to the associated communication point data set. This causes formatting of the communication point data set to be implemented so as to select designated elements from the communication point data set and arrange them in the appropriate position relative to one another or format them in a way appropriate for the selected data. In this fashion, the communication point data is arranged in a formatted set of communication point data—which in most instances will be different from the original set of communication point data. In block 824, the formatted communication point data can be output to the application. Thus, an unformatted set of data encompassing mailing address information can be formatted into a US postal service bulk mailing format and output to the data processor that physically addresses the envelopes. Once the communication point data is gathered, it will normally not need to be revised. However, from time to time the communication point data will need to be changed. For example, someone may move or change telephone numbers. In such an instance, the party will cause the need for change. However, in some instances, a regulatory agency may change the information. For example, a street may be renamed or a the telephone system may revise an area code. Similarly, a regulatory agency may decide to revise its communication-point-format. Thus, for example, the US postal service may change from a 5 digit zip code to a 10 digit zip code. Or spacing may be required between certain elements in an address to enhance automated processing of addresses.

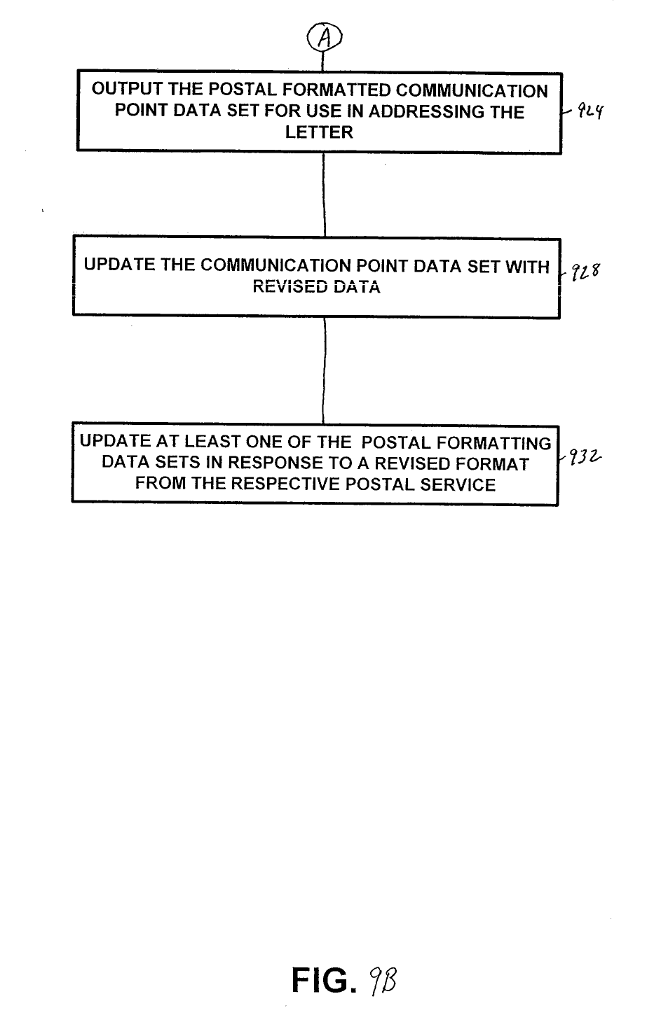

FIGS. 9A and 9B illustrate a flow chart 900 for implement formatting of postal service information according to one embodiment of the invention. In block 904, a communication point data set is stored. The communication point data set comprises data for addressing an item of mail, such as street number, street, city, state, and zip code. In block 908, multiple postal formatting data sets are stored. Each postal formatting data set includes data that can be used to format addresses in a respective format. For example, one format could be for US express mail; another format could be for US first class mail; another format could be for US bulk mail; another format could be for Canadian postal service requirements; etc. Each of these formats are specified by a respective postal service. In block 912, a determination is made as to which service provider requires a formatted address. For example, a determination can be made that a data processor is performing a bulk mailing of credit card statements to US residents. In block 916, one of the postal formatting data sets is associated with one of the communication point data sets. Once these data sets are associated, the formatting can be implemented as shown in block 920. Namely, the postal format as defined by the associated postal formatting data set can be applied to the associated communication point data set. This produces a revised communication point data set arranged in accordance with the associated format. In block 924, the postal formatted communication point data set is output. For example, it can be output so as to be used in addressing the credit card statement. As described above, blocks 928 and 932 illustrate that the communication point data set and the postal formatting data sets can be revised from time to time.

It should be understood that use of the term “associate” in this specification is intended to mean that two or more data elements are grouped as an associative set of data. For example, two internal identifiers grouped as a unique data entry form an associative set. Furthermore, the two data entries that those two internal identifiers reference are also consequently formed as an associative set of data.

Similarly, it should be understood that the use of the term “relate” in this specification is intended to mean that two or more entities are established in a relationship with one another. Thus, when a particular party is related to a particular account, for example, a relationship is established between the particular party and the particular account. This is often implemented by associating the internal identifier for the particular party with the internal identifier for the particular account as a data set so as to identify the entities as being related to one another.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents.

While many different definitions have been used for purposes of this patent so as to clarify the meaning of the claim terms. It should be understood that these definitions are intended solely for that purpose. Such definitions are not necessarily adopted by any assignee for other legal matters.

What is claimed is:

1. A method of addressing a letter, said method comprising:
storing a communication point data set, said communication point data set comprising data for addressing an item of mail for mailing via a postal service;
storing a plurality of postal formatting data sets defining how to format said communication point data set, each of said plurality of postal formatting data sets defining a respective addressing format specified by a respective postal service.

2. The method as claimed in claim 1 and further comprising:
determining a service provider requiring a formatted address configured from said communication point data set.

3. The method as claimed in claim 2 and further comprising:
associating one of said postal formatting data sets with said communication point data sets.

4. The method as claimed in claim 3 and further comprising:
applying said associated postal formatting data set to said communication point data set so as to produce a postal formatted communication point data set, said postal formatted communication point data set being different from said communication point data set.

5. The method as claimed in claim 4 wherein the content of said postal formatted communication point data set is a subset of the content of said communication point data set.

6. The method as claimed in claim 4 and further comprising:
outputting said postal formatted communication point data set for use in addressing said letter.

7. The method as claimed in claim 1 and further comprising:
updating said communication point data set with revised data.

8. The method as claimed in claim 1 and further comprising:
updating at least one of said postal formatting data sets in response to a revised format from said respective postal service.

9. A method of formatting communication point data, said method comprising:
storing a communication point data set;
storing a plurality of communication-point-formatting data sets defining how to format said communication point data set, each of said plurality of communication-point-formatting data sets defining a respective format for said content as specified by a respective format setting entity;
associating one of said communication-point-formatting data sets with said communication point data set based upon said determined application.

10. The method as claimed in claim 9 and further comprising:
determining an application for said communication point data set.

11. The method as claimed in claim 9 and further comprising:
determining an application for said communication point data set prior to said associating said one of said communication-point format data sets with said communication point data set.

12. The method as claimed in claim 9 and further comprising:
applying said associated communication-point-formatting data set to said communication point data set so as to produce a formatted communication point data set, said formatted communication point data set being different from said communication point data set.

13. The method as claimed in claim 9 and further comprising:
determining an application for said communication point data set; and
outputting said formatted communication point data set to said application.

14. The method as claimed in claim 9 and further comprising:
updating said communication point data set with revised data.

15. The method as claimed in claim 9 and further comprising:
updating at least one of said communication-point-formatting data sets in response to a revised format from said respective format setting entity.

16. The method as claimed in claim 10 wherein said application comprises addressing a letter to conform with US Postal service discounted mailing guidelines.

17. The method as claimed in claim 10 wherein said application comprises addressing a letter to conform with Canadian Postal Authority discounted mailing guidelines.

18. A method of formatting communication point data, said method comprising:
storing a communication point data set;
storing a plurality of communication-point-formatting data sets defining how to format said communication point data set, each of said plurality of communication-point-formatting data sets defining a respective format for said content as specified by a respective format setting entity;
determining an application for said communication point data set;
associating one of said communication-point-formatting data sets with said communication point data set based upon said determined application;
applying said associated communication-point-formatting data set to said communication point data set so as to produce a formatted communication point data set, said formatted communication point data set being different from said communication point data set; outputting said formatted communication point data set to said application;
updating said communication point data set with revised data;
updating at least one of said communication-point-formatting data sets in response to a revised format from said respective format setting entity.
